(19) United States
(12) Patent Application Publication
(10) Pub. No.: US 2026/0352630 A1
(43) Pub. Date: Nov. 5, 2026

(54) COMPUTER NETWORK ISOLATOR FOR A PERIPHERAL ACCESSORY AND METHODS OF USE

(71) Applicant: Bradley John Klein, Chonburi (TH)

(72) Inventor: Bradley John Klein, Chonburi (TH)

(21) Appl. No.: 19/198,060

(22) Filed: May 4, 2025

(51) Int. Cl. H04L 9/40

(52) U.S. Cl. CPC H04L 63/0236; H04L 63/1416; H04L 63/1425; H04L 63/1441

(57) ABSTRACT

Described is a network isolator and method for improving computer network security when using peripheral accessories such as video cameras or sensors, including unvetted or foreign-made devices. The network isolator includes physically separated first and second input/output ports, enabling the connection of one or more peripheral devices while preventing unauthorized communications from reaching the secure network. The isolator operates by passing commands from the network to the peripheral devices and relaying only those signals that are generated in direct response to such commands. All other traffic is blocked, and any unauthorized data or commands embedded in the signal are removed through inspection. Each signal is routed solely to its designated computer on the network. The system supports both wired and wireless configurations for connecting to peripherals and the network, providing a scalable and cost-effective solution for secure integration of conventional and commercially available accessories without compromising network integrity.

### BACKGROUND

Without limiting the scope of the invention, its background is described in connection with computer networks, including connected peripheral accessories. More particularly, the invention describes a device and method for isolating a signal received from the peripheral accessory to safeguard the computer network from malicious intrusions and attacks.

In large-scale computer networks, the integration of peripheral devices such as video cameras, remote sensors, and similar network-connected hardware introduces significant security vulnerabilities that can be exploited by malicious actors. These devices, often categorized under the Internet of Things (IoT), are typically equipped with embedded operating systems and network interfaces, making them viable entry points for unauthorized access and cyberattacks. A primary concern is that many of these peripherals operate with minimal built-in security, often using outdated firmware, hardcoded credentials, or unsecured communication protocols, which can be exploited to gain footholds within the broader network infrastructure.

Video surveillance systems, for instance, when compromised, can be used not only for unauthorized monitoring but also as relay points for advanced persistent threats (APTs). Attackers can exploit open ports or unpatched vulnerabilities in camera firmware to inject malware, perform lateral movement across internal systems, or intercept and manipulate video streams. Similarly, remote sensors—deployed for environmental monitoring, automation, or telemetry—can be compromised to exfiltrate data, introduce false readings, or serve as covert channels for command-and-control (C2) operations. These devices, often deployed at scale and in distributed locations, increase the overall attack surface and reduce visibility for network administrators, particularly if they are not integrated into centralized monitoring or endpoint protection systems.

Moreover, once compromised, such peripherals can function as persistent threats, capable of maintaining access even after detection efforts on traditional endpoints. Their role as low-privilege yet network-accessible nodes makes them attractive for reconnaissance, data leakage, and launching further attacks within the network. The growing complexity and ubiquity of these devices demand robust security architectures that include segmentation, zero-trust principles, encrypted communication, and regular firmware auditing to mitigate the risks posed by peripheral-based intrusions in enterprise-scale environments.

In large-scale and high-security environments, such as military, defense, and critical infrastructure organizations, the use of foreign-produced peripheral accessories, including network-connected video cameras, remote sensors, and other embedded devices, presents a heightened and complex threat landscape. Beyond the risks associated with software vulnerabilities and poor configuration, these devices may contain intentionally embedded malicious hardware or firmware components designed to facilitate long-term surveillance, sabotage, or unauthorized data exfiltration. This threat is particularly acute when devices are manufactured or supplied by entities operating under jurisdictions with adversarial interests or insufficient oversight.

Such foreign-manufactured peripherals may include “hardware trojans”, covertly embedded during production or supply chain transit, which can remain dormant until activated via specific network conditions, commands, or environmental triggers. These hardware implants can silently siphon data, establish covert communication channels with external threat actors, or degrade the integrity and availability of network services. In sensitive enterprise environments, such as government agencies, defense contractors, and military installations, these vulnerabilities represent not just a cyber risk, but a potential vector for “state-sponsored espionage”, sabotage, or strategic disruption.

The risk extends significantly with “surveillance devices” such as network-based security cameras, drones, and biometric access systems, which inherently gather high volumes of sensitive operational data. If compromised, they provide adversaries with direct visual or situational intelligence, such as monitoring troop movements, facility layouts, or access control protocols in real time. Similarly, remote sensors deployed in battlefield or critical infrastructure contexts, such as power grids, command centers, or nuclear facilities, can be manipulated to falsify telemetry data, disrupt automated controls, or cloak the presence of malicious activity elsewhere in the network.

Furthermore, these devices often operate outside the scope of traditional endpoint protection platforms and may be deployed in environments with limited physical or network segmentation, compounding the risk of lateral propagation following initial compromise. Attackers exploiting these devices can escalate privileges, establish long-term persistence, and evade detection by blending into normal network behavior, particularly when the malicious components are integrated at the silicon level or within proprietary firmware.

To address this multifaceted threat, high-value targets usually adopt a “zero-trust hardware policy”, emphasizing rigorous supply chain risk assessments, secure procurement practices, and detailed hardware and firmware vetting, often in collaboration with national cybersecurity authorities or trusted industry partners. Techniques such as side-channel analysis, firmware validation, and hardware attestation should be employed to verify device integrity before deployment. In addition, strict network segmentation, continuous monitoring of peripheral behavior, and prompt decommissioning of unverified foreign devices are critical to defending against the strategic threats posed by potentially compromised foreign-produced peripherals in sensitive environments.

While rigorous verification of peripheral accessories and reliance on a limited pool of approved vendors are essential components of a secure hardware supply chain, especially in high-value or mission-critical environments, they introduce significant practical and operational limitations, primarily driven by cost, scalability, and technological diversity.

Cost-related constraints are among the most prohibitive. Comprehensive hardware verification, which may include techniques such as reverse engineering, side-channel analysis, firmware auditing, electromagnetic emissions testing, and secure boot validation, requires specialized facilities, skilled personnel, and highly sensitive equipment. These processes are not only time-consuming but also resource-intensive, making it economically unfeasible to apply them uniformly across all deployed devices in large-scale environments. For organizations managing thousands or millions of peripheral units ranging from sensors to imaging systems, performing deep hardware assurance on each component can be cost-prohibitive, especially when lifecycle turnover or technological upgrades occur frequently.

Additionally, reliance on a narrow pool of approved vendors, while reducing supply chain exposure, can lead to monopolistic pricing, procurement bottlenecks, and reduced innovation. Vendors with security clearances or government certifications may charge premium rates, and their production capacity may not meet the scale or specificity of all organizational needs. This constraint can also stifle access to cutting-edge or niche technologies, especially in fast-evolving sectors like AI-driven sensors or advanced imaging systems, where non-traditional or international manufacturers may lead in innovation but fall outside the approved vendor list due to geopolitical or regulatory concerns.

Moreover, vendor restrictions and costly verification processes can impair operational agility, particularly in scenarios requiring rapid deployment or replacement of hardware, such as emergency response, battlefield conditions, or dynamic industrial settings. Delays in approval cycles and sourcing challenges can hinder mission readiness or disrupt continuity of operations.

There is also a risk of over-reliance on a small set of “trusted” suppliers, which can itself become a vulnerability. A single point of compromise in a trusted supply chain, whether through insider threats, coercion, or unnoticed tampering, could have wide-reaching consequences, affecting entire fleets of devices under the assumption of security.

The increasing integration of conventional peripheral devices, such as video surveillance cameras and environmental sensors, into large-scale and high-security networks creates a pressing need for novel systems and methods that can securely accommodate these widely available technologies while maintaining a high level of cybersecurity and reducing the risk of network-based attacks.

### SUMMARY

Accordingly, it is an object of the present invention to overcome these and other drawbacks of the prior art by providing a novel network isolator capable of disrupting all unauthorized signals and commands that may be generated using a peripheral accessory from reaching various computers on the computer network.

It is another object of the present invention to provide a method of improving security of a computer network by providing a network isolator for attachment of one or more peripheral accessories thereto, so that the signal generated by each peripheral accessory can only be passed to the computer designated on the computer network for receiving such a signal.

It is a further object of the present invention to provide an inexpensive network isolator configured to allow the use of unvetted peripheral accessories, including foreign-made accessories, without compromising the security of the computer network itself.

In embodiments, one method for improving computer network security may include the following steps:
a. providing a network isolator with a first input/output port which may be operatively connected to a peripheral accessory. The network isolator may further include a second input/output port, which may be operatively connected to the computer network. Importantly, the first input/output port is physically separated from the second input/output port to prevent unauthorized communication that may originate from the peripheral accessory;
b. operating the network isolator to communicate with the peripheral accessory via the first input/output port. Such communication may include passing a command from the computer network received via the second input/output port; and
c. operating the network isolator to communicate with the computer network via the second input/output port. Such communication may include passing a signal from the peripheral accessory, which, in turn, may be received via the first input/output port. Importantly, the signal is generated by the peripheral accessory only in response to the command from the computer network.

According to the present invention, the network isolator may be configured to block all traffic from the peripheral accessory that is not generated by the peripheral accessory in response to a command from the computer network. Additionally, the network isolator may be further configured to block all traffic from the peripheral accessory that is not directed to a computer designated to receive the signal from the peripheral accessory.

The network isolator may be also configured to inspect the signal generated by the peripheral accessory and remove unauthorized data and commands therefrom before passing the signal to the computer on the computer network designated to receive that signal.

In embodiments, one or more peripheral accessories, such as a plurality of video cameras, may be operatively attached to the network isolator via wireless or wired connections using the first input/output port. The second input/output port of the network isolator may also include one or more wired or wireless connectors or ports to facilitate its secure communication with one or more computers on the computer network.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a block diagram of the network isolator for attachment of a single peripheral accessory to a computer network.

FIG. 2 is a block diagram of an exemplary configuration for the attachment of several video cameras to one or more computers on a computer network.

FIG. 3 is another exemplary configuration for the attachment of several video cameras to one or more computers on a computer network.

### DETAILED DESCRIPTION OF PREFERRED EMBODIMENTS OF THE INVENTION

The following description sets forth various examples along with specific details to provide a thorough understanding of the claimed subject matter. It will be understood by those skilled in the art, however, that claimed subject matter may be practiced without one or more of the specific details disclosed herein. Further, in some circumstances, well-known methods, procedures, systems, components, and/or circuits have not been described in detail in order to avoid unnecessarily obscuring the claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

To enable the secure use of commercially available video cameras and sensors, especially in high-value, sensitive, or large-scale environments such as government installations, industrial systems, and critical infrastructure, security architectures must evolve beyond traditional trust-based or perimeter-centric approaches. The conventional model of relying exclusively on a small set of vetted vendors or performing exhaustive verification of each device is not only cost-prohibitive but also hinders operational scalability and technological innovation. In contrast, the present invention embraces a device-agnostic and behavior-driven model that prioritizes systemic resilience and dynamic threat containment over static assumptions of trust based on device origin or certification.

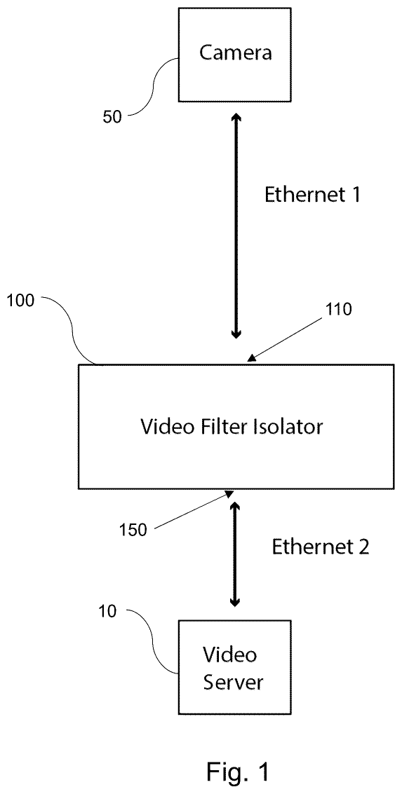

A cornerstone of the present invention is the implementation of a hardware-based isolation environment by using a network isolator 100 (see FIGS. 1-3), which allows untrusted or semi-trusted devices, such as off-the-shelf video cameras and environmental sensors 50, to function safely while sending their signals to a secure computer network. The peripheral accessories 50 described below can be used together with the network isolator 100 to construct “sandboxed” zones that tightly control the execution context and system-level permissions of peripheral devices. In these sandboxes, peripheral accessories 50 are allowed to perform their intended functions, such as capturing video, detecting motion, or measuring temperature, while being physically isolated and programmatically restricted from accessing or influencing critical network components, sensitive data stores, or system management interfaces.

This form of containment is particularly valuable in mitigating the risks associated with supply chain attacks, firmware-level backdoors, or malicious hardware implants, which may be embedded in foreign-manufactured peripherals. Even if a peripheral accessory 50 is compromised, isolation by the network isolator 100 ensures that any malicious code is restricted to a minimal execution environment and cannot conduct lateral movement across the network, escalate privileges, or initiate unauthorized data exfiltration. This approach reflects a defense-in-depth philosophy, wherein no peripheral accessory is implicitly trusted and every interaction is mediated and monitored.

Complementing hardware-level isolation, behavioral analysis and real-time anomaly detection systems may be added to provide a dynamic method for verifying the ongoing integrity and legitimacy of device activity. Using machine learning and AI-driven models, these systems establish baseline behavior profiles for cameras and sensors, defining what “normal” looks like in terms of data rates, control signals, communication patterns, and operational outputs. Any deviation from this norm, such as an unexpected firmware update, unusual network communication to an external IP address, or anomalous data payload, can be flagged for investigation or trigger automated containment responses. This behavioral approach allows organizations to detect zero-day threats, firmware exploits, and covert data leaks in real time, even in devices that have not been explicitly verified at the hardware level.

The network isolator 100 is a key component of this solution, which acts as an intermediary between peripheral devices and the core computer network. One or more of the network isolators 100 may be configured to be responsible for enforcing protocol compliance, sanitizing data inputs, and verifying the authenticity of communications. By functioning as policy enforcement points, these network isolators decouple the untrusted edge (where sensors and cameras reside) from the trusted core infrastructure.

The basic configuration of the system is illustrated in FIG. 1 and represents a secure architecture for integrating one peripheral accessory (for example, a video camera or a sensor device) into a computer network while maintaining strong cybersecurity protections. Central to the system is a video filter isolator, which functions as a network isolator positioned between potentially untrusted edge devices, such as video cameras or environmental sensors, and the core computing infrastructure. While the example focuses on video cameras, the design and operation are applicable to a wide range of peripheral accessories and sensors.

The video filter isolator 100 may feature two distinct input/output ports: a first input/output port 110, which interfaces with the external peripheral device 50, and a second input/output port 150 that connects to the internal computer network infrastructure, such as a video server in this example. The first input/output port 110 may enable connection to the video camera 50 using various wired or wireless protocols, such as Ethernet 1, WiFi 1, or Bluetooth 1. The second input/output port 150 may link the video filter isolator 100 to core network components such as a video server 10, or other suitable computers and computer systems, including network-attached storage (NAS), user terminals, or network switches, as the invention is not limited in this regard. Various wired and wireless connection methods may be used for this communication, such as Ethernet 2, Virtual WiFi 2, or Virtual Bluetooth 2 protocols. In embodiments, the connection between the network isolator 100 and the peripheral accessory 50 may be different from the connection of the network isolator 100 to the computer on the computer network so that the peripheral accessory 50 may only communicate with the network isolator and not with any other computers on the computer network. Using physically separate interfaces and connections designed to completely isolate communications from the peripheral accessory ensures there is no direct pathway between the untrusted peripherals and the internal network, effectively enforcing strict network isolation.

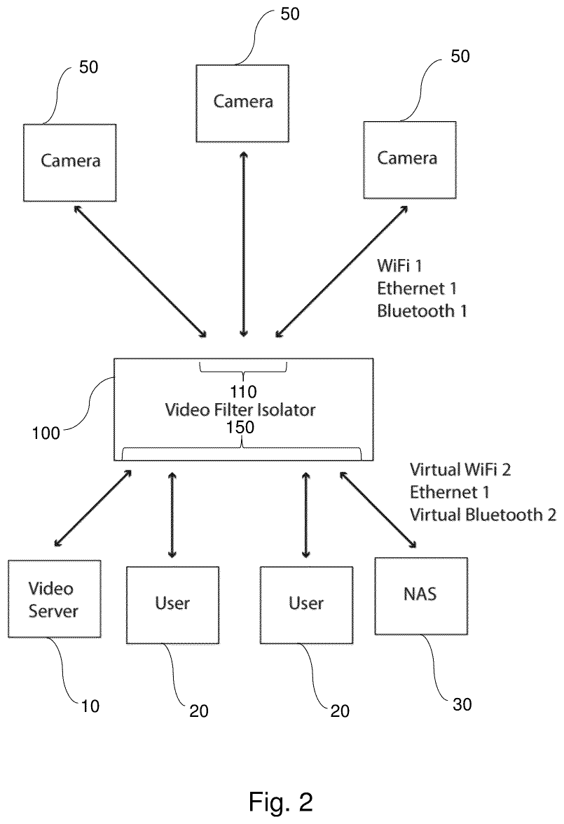

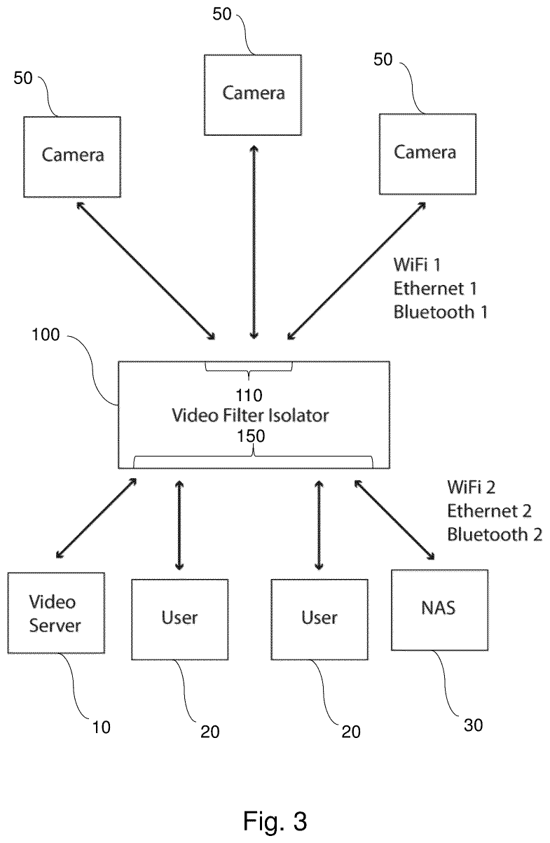

FIGS. 2 and 3 illustrate alternative configurations of the network isolator system 100 in which multiple peripheral video cameras 50 are securely integrated into a network environment while maintaining strict isolation between the untrusted edge devices and the trusted core infrastructure. In these configurations, a network isolator 100 is used to mediate all communications between the peripheral video cameras 50 and the rest of the network. The video cameras 50 are operatively attached to the first set of input/output ports 110 of the network isolator 100, which are dedicated exclusively to peripheral device connections. These ports may accommodate multiple video cameras simultaneously, enabling the system to scale across a broad surveillance deployment or multi-sensor environment.

The input/output ports 110 of the network isolator 100 are designed as flexible, modular interfaces capable of supporting a wide range of physical and virtual connectivity types to accommodate diverse peripheral accessories. These ports may be implemented as virtual ports configured to handle various wireless communication protocols, such as WiFi, Bluetooth, or other radio-frequency-based technologies. In these configurations, the ports operate through software-defined radio modules or dedicated wireless interfaces that establish isolated, secure wireless channels to communicate with peripheral devices like video cameras, environmental sensors, or remote monitoring units.

Alternatively, input/output ports 110 may be configured as physical first connectors compatible with standard wired communication interfaces. These include commonly used cable types such as Ethernet (e.g., RJ45 connectors), USB, or serial connectors, which are designed to establish a reliable and direct connection with peripheral accessories using structured cabling. In the case of Ethernet, the ports may support Power over Ethernet (PoE), allowing a single cable to provide both data connectivity and power to the accessory, simplifying deployment in a field or industrial environments.

The dual capability of first ports 110 to operate as either virtual wireless interfaces or physical wired connectors provides the system with high adaptability and scalability. It enables secure integration of a broad array of commercial devices without requiring specialized or proprietary cabling. Regardless of the connection type, each port remains logically and electrically isolated from the core network ports, ensuring that any data received from the peripheral accessory 50 is fully inspected, filtered, and verified before being forwarded to the trusted network infrastructure. This design supports both centralized and distributed sensor deployments while maintaining strong security postures against unauthorized access or signal injection from external devices.

The second input/output ports 150 of the network isolator 100 may be architected to provide secure, controlled communication pathways between the network isolator 100 and the trusted components of a computer network. These ports may be implemented as a plurality of individual second input/output ports, with each individual port specifically configured for operative connection to a designated computer or endpoint within the network. This one-to-one or one-to-few mapping allows the network isolator to enforce precise data routing policies and ensure that video streams or sensor outputs from individual peripheral devices are delivered only to their authorized recipients.

The second input/output ports of the network isolator may be realized in two primary forms: virtual ports and physical second connectors. In the virtual implementation, one or more second input/output ports may be configured as software-defined or virtual communication interfaces, capable of establishing secure wireless connections with corresponding computers on the network. These virtual input/output ports may operate over standard wireless protocols such as WiFi, Bluetooth, or other radio-based communication methods and are closely integrated with the system's security policies to ensure that only pre-approved, authenticated devices can access the communication channel.

Importantly, these virtual wireless input/output ports, such as Virtual Wireless First Input/Output Port or Ports and Virtual Wireless Second Input/Output Port or Ports, may be implemented using a single physical radio module. This means that a single WiFi or Bluetooth radio chip within the network isolator can support multiple virtual input/output ports simultaneously. The logical separation between these virtual ports may be achieved not by physical hardware, but by distinct encryption domains, each defined by a unique encryption key or password. By assigning different encryption credentials (for example, WPA2 or WPA3 passphrases) to each virtual first or second input/output port, the system effectively creates isolated communication channels that operate independently, even though they share the same underlying hardware and radio frequency spectrum.

This design allows the network isolator to reduce hardware complexity and cost while still enforcing strong logical and cryptographic separation between different communication paths. For example, Virtual Wireless First Input/Output Port may be used to interface with a peripheral accessory such as a video camera, while Virtual Wireless Second Input/Output Port securely transmits the filtered and verified data to a designated computer on the secure network. Though both virtual ports operate over the same frequency band and radio hardware, the encryption separation ensures that data cannot leak or be intercepted across domains.

Such an architecture not only supports efficient resource utilization but also enhances security and scalability, allowing the network isolator to serve multiple roles and maintain compartmentalization without requiring multiple discrete wireless modules. This approach is particularly advantageous in compact or embedded systems where hardware space is limited, yet high security and flexible connectivity are essential.

Alternatively, one or more second input/output ports may be configured as physical connectors, such as RJ45 Ethernet jacks, USB interfaces, Modbus serial interfaces, or other hardware-based links. These provide a dedicated, wired pathway to a specific computer or network device, ensuring robust and stable connectivity while further enhancing security through physical segmentation. In some configurations, these physical ports may support additional security features such as MAC address filtering, port locking, or directional data flow enforcement to prevent any unauthorized return traffic from reaching the isolator or connected peripherals.

By offering both virtual and physical second input/output ports, the network isolator 100 may support a broad range of deployment scenarios, from wireless, decentralized systems to hardwired, high-security infrastructures, while maintaining strict isolation between untrusted peripherals and trusted network components.

Crucially, each first input/output port 110 may be physically separated from the second input/output ports 150 that connect to the internal computer network. This physical separation may involve the use of distinct network interfaces, separate internal circuitry, or even air-gapped internal pathways within the network isolator, thereby preventing any direct physical, electrical, or logical bridge between the camera-facing and network-facing interfaces. This isolation strategy eliminates any potential attack vector whereby a compromised peripheral accessory could directly inject malicious traffic into the computer network.

Within the network isolator 100, a dedicated controller governs all communications. The controller is programmed to operate in a highly controlled, deterministic manner. It first establishes communication with each video camera 50 via the first input/output port 110, initiating a secure session and managing camera configuration and streaming behavior. Commands from the computer network, received via the second input/output port 150, may be selectively relayed to the appropriate camera 50 only after their respective validation. When a camera responds, typically by generating a video stream in response to a command, the controller of the network isolator transmits this stream back through the second input/output port 150 to the designated recipient computer on the network, such as a video server 10, a user observation terminal 20, or a NAS storage 30.

In some embodiments, the controller may enforce strict traffic filtering policies. It may block any data originating from cameras 50 that is not explicitly generated in response to a valid command received from the computer network. This means that unsolicited or anomalous transmissions from cameras 50, such as attempts to initiate outbound connections, broadcast unauthorized packets, or establish tunnels to remote systems, are immediately discarded. Moreover, the controller may ensure that any valid video stream is only routed to the designated computing resource authorized to receive it. This prevents lateral propagation of device-originated traffic within the network and minimizes the risk of exfiltration or unauthorized redistribution.

The network isolator 100 may include a targeted signal routing mechanism that ensures each video stream originating from a specific peripheral video camera 50 is delivered only to one or more designated computers on the network. This step introduces an important layer of signal segregation and destination control, wherein individual video signals from the plurality of video cameras 50 are not broadcast or sent to arbitrary endpoints on the network, but rather are selectively routed to one or more pre-authorized computing devices explicitly configured to receive them.

This functionality is particularly critical in sensitive or high-security environments, where information compartmentalization is essential to maintain operational integrity and minimize exposure in the event of a breach. For example, in a military surveillance context, video feeds from cameras 50 monitoring different zones may be intended for different operational units, and it would be both inefficient and insecure for all streams to be available to all endpoints. By assigning unique routing policies for each video stream, the system can isolate access to camera data, enforcing role-based or location-based data flows.

The network isolator's controller plays a central role in this process by maintaining an internal mapping of camera-to-recipient associations. When a video camera generates a signal in response to a command from the network, the isolator evaluates the signal against this mapping and forwards the stream only to the authorized computer or endpoint. If a mismatch is detected, such as an attempt to send a stream to an unauthorized recipient, the signal is automatically dropped or blocked, and optionally logged for audit purposes.

This approach also introduces robust defenses against man-in-the-middle attacks and internal data leakage, since the isolator ensures that signals never traverse the network freely or indiscriminately. Even in the case of a compromised camera or an insider threat attempting to reroute traffic, the isolator enforces a strict one-to-one or one-to-few communication pattern, anchored by predefined policies that cannot be overridden by the peripheral devices themselves.

Furthermore, this targeted signal routing method provides scalability and manageability in large camera deployments. It simplifies network architecture by enabling centralized management of camera-to-recipient relationships, reduces unnecessary network traffic, and ensures compliance with organizational data policies or legal frameworks governing video surveillance data distribution.

Another important aspect of operating the network isolator 100 for improving network security is the capability to inspect the signal generated by a peripheral accessory, such as a video camera or sensor, and remove any unauthorized data, commands, or anomalous content before that signal is allowed to enter the trusted portion of the computer network. This inspection process serves as yet another security enforcement point, effectively transforming the network isolator 100 into a content-aware security filter that sits between potentially untrusted devices and high-value network resources.

The inspection process begins with the network isolator 100 receiving the raw signal output from the peripheral device via the first input/output port 110. This signal may include the expected primary data payload (e.g., a video stream, image data, or sensor readings), but in many cases, it may also contain metadata, embedded commands, control signals, or other data types, some of which may be benign, and others potentially malicious or unintended. These extraneous components might be the result of misconfigured firmware, hidden backdoors, unauthorized telemetry, or even deliberate obfuscation introduced during manufacturing.

Once the signal is received, the network isolator's internal controller may perform a comprehensive signal parsing and deep packet inspection (DPI). This includes decoding the signal format, identifying standard versus non-standard protocol layers, and isolating the core content from any surrounding or encapsulated commands. During this stage, the network isolator 100 may compare the contents of the signal against a known whitelist of acceptable data formats, structures, and behaviors, as well as a blacklist of suspicious patterns, such as command-and-control messages, unexpected outbound requests, or device self-update instructions. Machine learning-based anomaly detection or rule-based validation may also be applied to identify signals that deviate from normal operational baselines.

Any portion of the signal that fails validation, such as unauthorized configuration commands embedded within the data stream, covert signaling packets, or metadata indicating attempts to reach out to external destinations, may be stripped from the signal before it is relayed through the second input/output port 150. In cases of significant deviation or clearly malicious content, the isolator may choose to quarantine the entire signal, halt communication with the peripheral, and trigger alerts to system administrators for investigation.

This process ensures that only clean, pre-authorized data generated by the peripheral in response to legitimate network commands is permitted to traverse the isolation boundary. The removal of unauthorized elements not only neutralizes potential attack vectors embedded in peripheral-originated signals but also prevents the propagation of firmware-level exploits, data leakage, or network reconnaissance attempts that might otherwise bypass conventional firewalls or endpoint protection tools.

Additionally, this inspection and sanitization process enhances the integrity and reliability of downstream systems, such as video analytics platforms or control centers, by ensuring they are fed with predictable, validated, and safe inputs. It allows organizations to make operational decisions based on trustworthy data while maintaining a secure and compartmentalized network environment.

The present invention supports a comprehensive approach to security and can be integrated into a “zero-trust security model”, where no device or user, regardless of location or manufacturer, is assumed to be secure by default. In a zero-trust framework, each device must authenticate its identity and demonstrate behavioral compliance continuously, not just at the time of onboarding.

In further embodiments, identity management solutions, such as public key infrastructures (PKIs), digital certificates, and cryptographic signatures, can be used in tandem with behavioral controls and network isolators described above to continuously validate device trustworthiness throughout its operational life.

It is contemplated that any embodiment discussed in this specification can be implemented with respect to any method of the invention, and vice versa. It will also be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A method for improving computer network security comprising the following steps:
a. providing a network isolator with a first input/output port operatively connected to a peripheral accessory and a second input/output port operatively connected to the computer network, wherein the first input/output port is physically separated from the second input/output port,
b. operating the network isolator to communicate with the peripheral accessory via the first input/output port by passing a command from the computer network received via the second input/output port, and
c. operating the network isolator to communicate with the computer network via the second input/output port by passing a signal from the peripheral accessory received via the first input/output port, the signal is generated by the peripheral accessory in response to the command from the computer network,
wherein the network isolator is configured to block all traffic from the peripheral accessory that is not generated by the peripheral accessory in response to the command from the computer network,
wherein the network isolator is further configured to block all traffic from the peripheral accessory that is not directed to a computer designated to receive the signal from the peripheral accessory.

2. The method for improving computer network security, as in claim 1, wherein the peripheral accessory is a video camera and the signal from the peripheral accessory is a video signal.

3. The method for improving computer network security, as in claim 1, wherein the network isolator is operatively connected to a plurality of video cameras via a plurality of individual first input/output ports, and wherein in steps (b) and (c) operating the network isolator comprises individual communications with each video cameras via the corresponding plurality of individual first input/output ports.

4. The method for improving computer network security, as in claim 3, wherein step (b) further comprises a step of operating the network isolator for passing individual commands from the computer network to corresponding individual video cameras.

5. The method for improving computer network security, as in claim 3, wherein step (c) further comprises a step of operating the network isolator for passing video signals from the plurality of video cameras received via the corresponding plurality of individual first input/output ports, the signals are generated by the plurality of video cameras in response one or more commands from the computer network.

6. The method for improving computer network security, as in claim 5, wherein step (c) further comprises a step of passing individual video signals from the plurality of video cameras to one or more computers on the computer network, each of the one or more computers is designated to receive one or more individual video signals from corresponding video cameras.

7. The method for improving computer network security, as in claim 2, wherein step (c) comprises operating the network isolator for passing the video signal from the video camera received via the first input/output port to one or more computers on the computer network designated to receive the video signal from the video camera.

8. The method for improving computer network security, as in claim 1, wherein step (c) further comprises a step of operating the network isolator for inspecting the signal generated by the peripheral accessory and removing unauthorized data and commands therefrom.

9. The method for improving computer network security, as in claim 1, wherein the network isolator is operatively connected via the first input/output port to one or more peripheral accessories via a first connection network, and wherein the network isolator is operatively connected via the second input/output port to the computer network via a second connection network, thereby the one or more peripheral accessories and the first connection network are separated from the computer network and from the second connection network by the network isolator.

10. A network isolator for improving computer network security when using a peripheral accessory, the network isolator comprising:
a. a first input/output port configured to be operatively connected to the peripheral accessory,
b. a second input/output port configured to be operatively connected to the computer network, wherein the first input/output port is physically separated from the second input/output port, and
c. a controller configured to:
i. communicate with the peripheral accessory via the first input/output port by passing a command from the computer network received via the second input/output port,
ii. communicate with the computer network via the second input/output port by passing a signal from the peripheral accessory received via the first input/output port, the signal is generated by the peripheral accessory in response to the command from the computer network,
iii. block all traffic from the peripheral accessory that is not generated by the peripheral accessory in response to the command from the computer network, and
iv. block all traffic from the peripheral accessory that is not directed to a computer designated to receive the signal from the peripheral accessory.

11. The network isolator, as in claim 10, wherein the first input/output port comprises a plurality of individual first input/output ports, each individual first input/output port configured for operative connection to a designated peripheral accessory assigned thereto.

12. The network isolator, as in claim 11, wherein at least one individual first input/output port is a virtual first port configured for designated wireless communication with a corresponding peripheral accessory.

13. The network isolator, as in claim 11, wherein at least one first individual input/output port is a first physical connector configured for designated wired attachment and communication with a corresponding peripheral accessory assigned thereto.

14. The network isolator, as in claim 10, wherein the second input/output port comprises a plurality of individual second input/output ports, each individual second input/output port configured for operative connection to a designated computer on the computer network.

15. The network isolator, as in claim 11, wherein at least one individual second input/output port is a virtual second port configured for designated wireless communication with a corresponding computer on the computer network.

16. The network isolator, as in claim 11, wherein at least one individual second input/output port is a second physical connector configured for designated wired attachment and communication with a corresponding computer on the computer network.

17. The network isolator, as in claim 10, wherein the controller of the network isolator is further configured to inspect the signal generated by the peripheral accessory and remove unauthorized data and commands therefrom before passing the signal to the computer on the computer network designated to receive the signal.
